(19) United States
(12) Patent Application Publication
(10) Pub. No.: US 2011/0069148 A1
(43) Pub. Date: Mar. 24, 2011

(54) SYSTEMS AND METHODS FOR CORRECTING IMAGES IN A MULTI-SENSOR SYSTEM

(75) Inventors: Peter W. J. Jones, Belmont, MA (US); Dennis W. Purcell, Medford, MA (US); Ellen Cargill, Norfolk, MA (US)

(73) Assignee: Tenebraex Corporation, Boston, MA (US)

(21) Appl. No.: 12/887,667

(22) Filed: Sep. 22, 2010

Related U.S. Application Data
(60) Provisional application No. 61/244,514, filed on Sep. 22, 2009.

(51) Int. Cl. H04N 5/225

(52) U.S. Cl. 348/36; 348/218.1; 348/E05.024

(57) ABSTRACT

The systems and methods described herein are directed to multi-sensor imaging systems for imaging scenes. In particular, the systems and methods described herein are directed to multi-sensor panoramic imaging systems having cameras with lenses offset from their respective sensors. By orienting sensors and lenses in the imaging system such that their optical axes are offset from one another, images may be captured by multiple sensors and stitched together with relatively little image processing and/or data interpolation.

### CROSS-REFERENCE TO RELATED APPLICATIONS

This application claims priority to and the benefit of U.S. Provisional Patent Application Ser. No. 61/244,514, filed Sep. 22, 2009, and entitled “Systems and Methods for Correcting Images in a Multi-Sensor System”, the entire contents of which are incorporated herein by reference.

### FIELD OF THE INVENTION

The systems and methods described herein relates generally to multi-sensor imaging, and more specifically to an optical system having a plurality of lenses, each offset from one or more sensors for, among other things, stabilizing an image and minimizing distortions due to perspective.

### BACKGROUND

Surveillance systems are commonly installed indoors in supermarkets, banks or houses, and outdoors on the sides of buildings or on utilities poles to monitor traffic in the environment. These surveillance systems typically include still and video imaging devices such as cameras. It is particularly desirable for these surveillance systems to have a wide field of view and generate panoramic images of a zone or a space under surveillance. In this regard, conventional surveillance systems generally use a single mechanically scanned camera that can pan, tilt and zoom. Panoramic images may be formed by using such a camera combined with a panning motor to shoot multiple times and then stitching the images captured each time. However, these mechanically scanned camera systems consume a lot of power, require plenty of maintenance and are generally very bulky. Furthermore, motion within an image may be difficult to detect from simple observation of a monitor screen because of the movement of the camera itself can generate undesirable visual artifacts.

Panoramic images may also be formed by using multiple cameras, each pointing in a different direction, in order to capture a wide field of view. With the advent of multi-sensor imaging devices capable of generating panoramic images by stitching together individual images from individual sensors, there has been an interest in adapting these multi-sensor imaging devices for surveillance and other applications. However, seamless integration of the multiple resulting images is complicated. The image processing required for multiple cameras or rotating cameras to obtain precise information on position and azimuth of an object takes a long time and is not suitable for most real-time applications. Accordingly, there is a need for improved surveillance systems capable of capturing panoramic images.

It is also desirable that cameras used in surveillance systems be mounted in locations that are relatively out of plain sight and are free from obstructions. Generally, to prevent obstructions from obscuring line of sight, these cameras (single or multi-sensor) are often mounted in a relatively high position and angled downward. However, images obtained from angled sensors tend to be distorted, and stitching together these images, to form a panorama, tend to be difficult and imperfect.

Accordingly, there is a need for improved systems and methods for multi-sensor imaging

### SUMMARY

As noted above, and as the inventors have identified, the angled orientation of many surveillance camera systems makes creating high-fidelity panoramic images from stitched individual images difficult. In particular, the inventors have identified that adjacent images obtained from angled cameras cannot be easily lined up and are mismatched from each other because each image suffers from distortion due to perspective (e.g., when the camera is angled downwards, vertical lines on the image tend to converge). Moreover, if the image subject or the camera platform is dynamic or moving, motion blur may be introduced. Consequently, stitching these images together requires significant interpolation of data, which in and of itself is likely to generate inaccurate results. The inventors have overcome these problems by developing systems and methods, described herein, that are directed to multi-sensor panoramic imaging systems having lenses offset from their respective sensors. By introducing an offset between the lenses and their respective sensors, the inventors have successfully shifted the field of view of the camera without substantially tilting it. Thus a multi-sensor surveillance camera located high above the ground can capture images below without much perspective distortion. Inventors have not only identified that perspective distortion adversely impacts stitching together images captured by a multi-sensor camera, but have resolved the problem by shifting the optical axis of the camera relative to the center of the sensor so as to limit distortion due to perspective. As described in more detail below, each sensor in a multi-sensor surveillance camera located high above the ground may be able to capture an image of a scene below without perspective distortion. Consequently, images from each sensor may be stitched together easily and accurately.

For purposes of clarity, and not by way of limitation, the systems and methods may be described herein in the context of multi-sensor imaging with variable or offset optical and imaging axes. However, it may be understood that the systems and methods described herein may be applied to provide for any type of imaging. Moreover, the systems and methods described herein can be used for a variety of different applications that benefit from a wide field of view. Such applications include, but not limited to, surveillance and robotics.

In one aspect, the systems and methods described herein include a multi-sensor system for imaging a scene. The multi-sensor system includes a plurality of cameras and a processor. Each camera may include a lens and sensor. The lens typically includes an optical axis or a principle optical axis. The sensor may be positioned behind the lens for receiving light from the scene. The sensor includes an active area for imaging a portion of the scene. The sensor may also include an imaging axis, perpendicular to the active area and intersecting a center region of the active area. The optical axis may be offset from the imaging axis so that the camera may record images having minimized distortion due to perspective. In certain embodiments, the plurality of cameras includes at least two cameras having overlapping fields of view. The processor may include circuitry for receiving images recorded by the sensors, and generating a panoramic image by combining the image from each of the plurality of cameras.

In certain embodiments, the plurality of cameras are positioned above the scene and the optical axis is vertically offset from the imaging axis such that optical axis is below the imaging axis. In other embodiments, the plurality of cameras are positioned below the scene and the optical axis is vertically offset from the imaging axis such that optical axis is above the imaging axis.

The multi-sensor system may include one or more offset mechanisms connected to one or more lenses for shifting the optical axis relative to the imaging axis. In certain embodiments, these offset mechanisms include at least one prism. In other embodiments, the offset mechanism includes a combination of one or more motors, gears and other mechanical components capable of moving lenses and/or sensors. The offset mechanism may be coupled to a processor and the processor may include circuitry for controlling the offset mechanism and shifting the one or more lenses. In certain embodiments, the multi-sensor system includes a detection mechanism configured to detect movement in the scene. In such embodiments, the processor includes circuitry for controlling the offset mechanism based on movement detected by the detection mechanism.

Additionally and optionally, the multi-sensor system may include one or more offset mechanisms connected to one or more sensors for shifting the imaging axis relative to the optical axis. The offset mechanism may be coupled to the processor and the processor may include circuitry for controlling the offset mechanism and shifting the one or more sensors. In certain embodiments, the processor includes circuitry for changing the active area on one or more sensors, thereby shifting one or more imaging axes. The active area may be smaller than the surface area of the sensor. In such embodiments, the processor may include circuitry for changing the addresses of one or more photosensitive elements to be read out. In other embodiments, the active area substantially spans the sensor.

In certain embodiments, the cameras are arranged on a perimeter of a circular region for spanning a 360 degree horizontal field of view. The plurality of cameras may be optionally mounted on a hemispherical or planar surface. The multi-sensor system may include an arrangement whereby the plurality of cameras includes two cameras arranged horizontally adjacent to one another with partially overlapping fields of view. In certain embodiments, the multi-sensor system may include a plurality of cameras and/or sensors arranged in multiple rows to form a two-dimensional array of cameras and/or sensors. Additionally and optionally, the plurality of cameras may be mounted on a moving platform and the offset between the optical axis and the imaging axis may be determined based on the motion of the moving platform.

In another aspect, the systems and methods described herein include methods for imaging a scene. The methods include providing a first camera having a first field of view and a second camera having a second field of view that at least partially overlaps with the first field of view. The first and second cameras may each include a lens and a sensor. The lens may include an optical axis offset from an axis perpendicular to the sensor and intersecting near a center of an active area of the sensor. The methods include recording a first image of a portion of a scene on the active area at the first camera, and recording a second image of a portion of the scene on the active area at the second camera. The methods may further include receiving at a processor the first image and the second image, and generating a panoramic image of the scene by combining the first image with the second image.

The methods may include providing a plurality of cameras positioned adjacent to at least one of the first and second camera. In certain embodiments, the methods further include determining a position for the first and second camera in relation to the location of the scene. In such embodiments, the methods may include selecting the offset between the optical axis and the imaging axis in each of the first and second camera based at least on the location of the scene relative to the position of the first and second camera.

The offset between the optical axis and imaging axis in at least one of the first and the second camera may be generated by physically offsetting at least one of the lens and sensor. Additionally and optionally, the active area may be smaller than the sensor in at least one of the first and second camera, and the offset between the optical axis and imaging axis in the first and the second camera may be generated by changing the active area on the sensor in at least one of the first and second camera. Changing the active area may include, among other things, changing a portion of photosensitive elements being read out.

### BRIEF DESCRIPTION OF THE FIGURES

The foregoing and other objects and advantages of the systems and methods described will be appreciated more fully from the following further description thereof, with reference to the accompanying drawings wherein:

FIGS. 1A-C depict a single-sensor imaging system having an optical axes parallel to an imaging axis, according to an illustrative embodiment of the invention;

FIG. 2 depicts the components of a multi-sensor imaging system, according to an illustrative embodiment of the invention;

FIGS. 3A-D depict a multi-sensor imaging system having two cameras for imaging a scene, according to an illustrative embodiment of the invention;

FIG. 4A-D depict another multi-sensor imaging system having two horizontally-angled cameras for imaging a scene, according to an illustrative embodiment of the invention;

FIG. 5 depicts a multi-sensor imaging system for imaging a scene from a vertically-angled perspective, according to an illustrative embodiment of the invention;

FIG. 6 depicts a method for generating a single image from two overlapping images of a scene;

FIGS. 7A and 7B depict a multi-sensor imaging system having offset lens-sensor pairs for imaging a scene, according to an illustrative embodiment of the invention;

FIGS. 7C and 7D depict a method for generating a single image from two overlapping images of a scene generated by imaging system of FIGS. 7A and 7B according to an embodiment of the invention;

FIGS. 8A and 8B depict a horizontally-angled, multi-sensor imaging system having offset lens-sensor pairs for imaging a scene, according to an illustrative embodiment of the invention;

FIGS. 8C and 8D depict a method for generating a single image from two overlapping images of a scene generated by imaging system of FIGS. 8A and 8B according to an embodiment of the invention;

FIGS. 9A-C depict alternate systems and methods for imaging a scene based on the active area of the sensor, according to illustrative embodiments of the invention;

FIG. 10 depicts a multi-sensor imaging system for imaging a panoramic scene, according to an illustrative embodiment of the invention;

FIG. 11 depicts an exemplary camera having an offset lens-sensor pair, according to an illustrative embodiment of the invention.

FIG. 12 is a flowchart depicting an exemplary process for imaging a scene, according to an illustrative embodiment of the invention.

### DETAILED DESCRIPTION OF THE ILLUSTRATIVE EMBODIMENTS

To provide an overall understanding, certain illustrative embodiments will now be described, including a multi-sensor imaging system with variable optical and imaging axes. However, it will be understood by one of ordinary skill in the art that the systems and methods described herein may be adapted and modified for other suitable applications and that such other additions and modifications will not depart from the scope thereof.

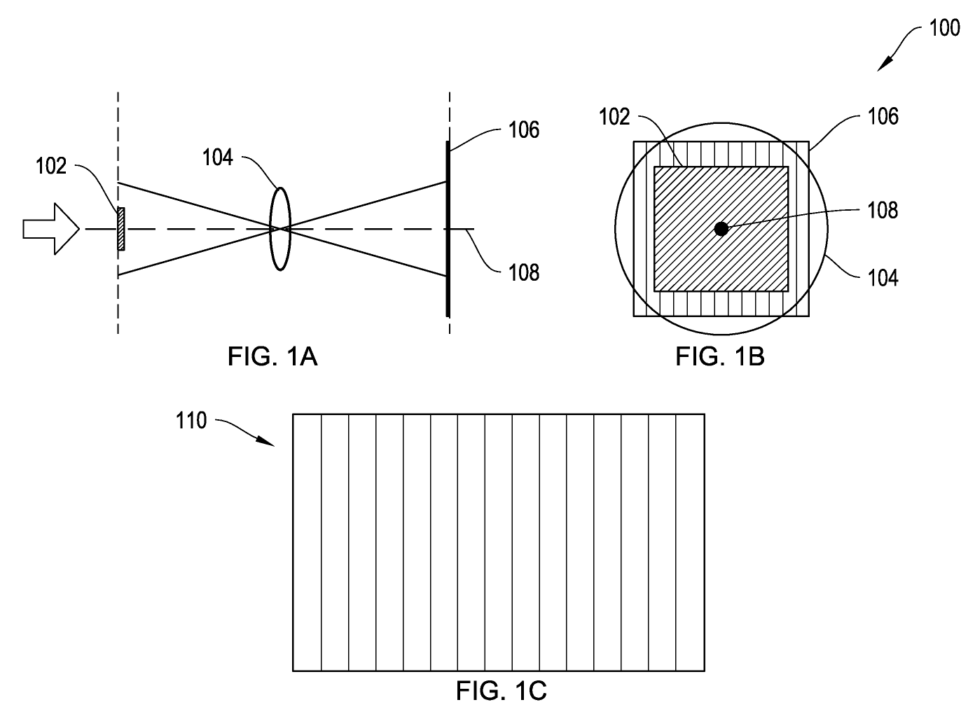

FIG. 1A-C depicts a single sensor imaging system 100, with an imaging sensor 102 and a lens 104. A side view of imaging system 100 is depicted in FIG. 1A, and a back view of system 100 is depicted in FIG. 1B, from the perspective of the leftmost block arrow in FIG. 1A. The axis passing through the center of the imaging sensor 102 (and perpendicular to the plane of sensor 102), the imaging axis, is substantially collinear to the axis of the lens 104, the optical axis. These collinear axes are represented by a single axis 108. Axis 108 is also collinear with the axis associated with the plane of image target 106, which is the axis perpendicular to the plane 106 and intersecting the center of the imaged area of the target. The imaging sensor 102 may be able to capture an image 110 of target 106 through lens 104. In one example, if the target 106 is a series of parallel lines, then the imaging system 100 may be able to capture image 110 of target 106. Because the imaging axis of the imaging sensor 102, the optical axis of the lens 104, and the imaged area of target 106 are collinear, the parallel lines of target 106 will appear as generally parallel lines in image 110.

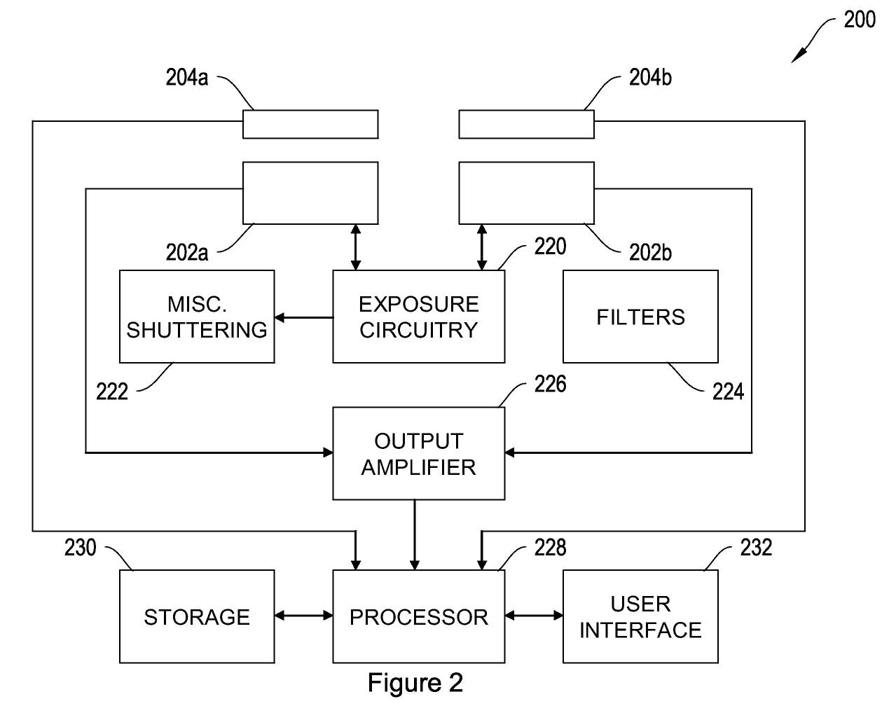

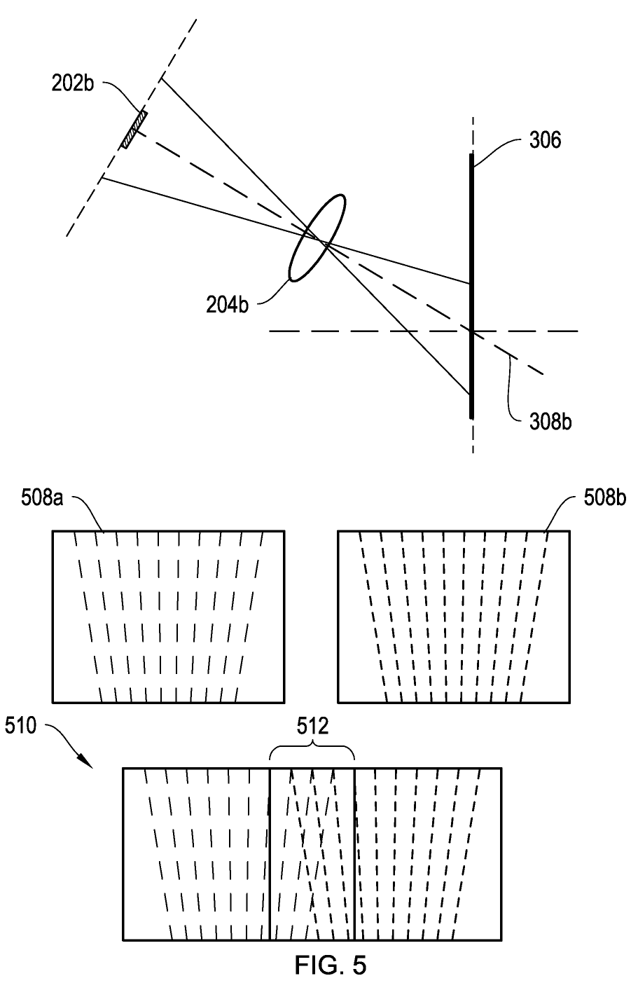

Image 110 represents the field of view of system 100. In particular, image 110 represents that portion of target 106 that is captured by sensor 102 in system 100. In certain embodiments, the coverage of the lens is greater than the area of the sensor. Consequently, image 110 may represent an area that is less than the area of target 106 and less than the coverage of the lens. The field of view of the system 100 is typically that portion of the target 106 which is captured by the system 100, in this case image 110. The field of view (horizontal or vertical) is roughly directly proportional to the dimensions of the sensor array (horizontal or vertical) and distance of the target 106 from the system 100, and inversely proportional to the focal length of lens 104. In the example of a surveillance system, the field of view is often times below the camera. Consequently, as described with reference to FIG. 5, the camera would need to be angled downward so that the desired portion of the target falls within the system's field of view. When the system is angled downward, the parallel lines in image 110 are no longer parallel due to perspective distortion. In a multi-sensor imaging system, such perspective distortion is especially undesirable because stitching images from the multiple sensors becomes more difficult. As will be described with reference to FIGS. 2 and 7-9, to resolve this issue, the lens 102 may be shifted so that the field of view of the system shifts downwards without having to angle the camera downward.

FIG. 2 depicts an illustrative multi-sensor imaging system 200 having two sensors positioned substantially adjacent to each other, according to an illustrative embodiment. In particular, system 200 includes imaging sensors 202a and 202b and associated lenses 204a and 204b that are positioned substantially adjacent to each other. Generally, system 200 may include two or more imaging sensors and associated lenses arranged vertically or horizontally with respect to one another without departing from the scope of the systems and methods described herein.

In certain embodiments, the imaging sensors 202a and 202b may include or be connected to one or more light meters (not shown). The sensors 202a and 202b are connected to exposure circuitry 220. The exposure circuitry 220 may be configured to determine an exposure value for each of the sensors 202a and 202b. In certain embodiments, the exposure circuitry 220 determines the best exposure value for a sensor for imaging a given scene. The exposure circuitry 220 is optionally connected to miscellaneous mechanical and electronic shuttering systems 222 for controlling the timing and intensity of incident light and other electromagnetic radiation on the sensors 202a and 202b. The sensors 202a and 202b may optionally be coupled with one or more filters 224. In certain embodiments, filters 224 may preferentially amplify or suppress incoming electromagnetic radiation in a given frequency range. Lenses 204a and 204b may be any suitable type of lens or lens array, and may be coupled with one or more offset mechanisms (not shown) that allow the optical axes of the lenses to shift with respect to the optical axes of their associated sensors. In some embodiments, the sensors may also be coupled with one or more offset mechanisms that allow sensor optical axes to shift with respect to lens optical axes. The offset mechanisms may also enable the lenses and/or sensors to tilt with respect to their associated sensors and/or lenses. The offset mechanisms may enable all of the lenses and/or sensors to shift and/or tilt simultaneously, or may allow one or more lenses and/or sensors to shift and/or tilt independent of the other lenses and sensors. The offset mechanisms may be coupled to processor 228. In some embodiments, the offset mechanisms may include one or more prisms (not shown) that allow the optical axes of the lenses and the sensors to shift with respect to each other. For example, the one or more prisms may be able to shift and/or tilt in order to redirect the light passing between the lenses and the sensors.

In some embodiments, sensor 202a includes an array of photosensitive elements (or pixels) distributed in an array of rows and columns (not shown). The sensor 202a may include a charge-coupled device (CCD) imaging sensor. In certain embodiments, the sensor 202a includes a complementary metal-oxide semiconductor (CMOS) imaging sensor. In certain embodiments, the sensor 202b is similar to the sensor 202a. The sensor 202b may include a CCD and/or CMOS imaging sensor. The sensors 202a and 202b may be positioned adjacent to each other, either vertically or horizontally. The sensors 202a and 202b may be included in an optical head of an imaging system. In certain embodiments, the sensors 202a and 202b may be configured, positioned or oriented to capture different fields-of-view of a scene. The sensors 202a and 202b may be angled depending on the desired extent of the field of view. During operation, incident light from a scene being captured may fall on the sensors 202a and 202b. In certain embodiments, the sensors 202a and 202b may be coupled to a shutter and when the shutter opens, the sensors 202a and 202b are exposed to light. The light may then converted to a charge in each of the photosensitive elements in sensors 202a and 202b, which may then be transferred to output amplifier 226. In certain embodiments, the active imaging area of an imaging sensor (i.e. the portion of the sensor exposed to light) may be smaller than the total imaging area of the imaging sensor. In some embodiments, the size and/or position of the active imaging area of an imaging sensor may be varied. Varying the size and/or position of the active imaging area may be done by selecting the appropriate rows, columns, and/or pixels of the imaging sensor to read out, and in some embodiments, may be performed by processor 228.

The sensors can be of any suitable type and may include CCD imaging sensors, CMOS imaging sensors, or any analog or digital imaging sensor. The sensors may be color sensors. The sensors may be responsive to electromagnetic radiation outside the visible spectrum, and may include thermal, gamma, multi-spectral and x-ray sensors. The sensors, in combination with other components in the imaging system 100, may generate a file in any format, such as the raw data, GIF, JPEG, TIFF, PBM, PGM, PPM, EPSF, X11 bitmap, Utah Raster Toolkit RLE, PDS/VICAR, Sun Rasterfile, BMP, PCX, PNG, IRIS RGB, XPM, Targa, XWD, PostScript, and PM formats on workstations and terminals running the X11 Window System or any image file suitable for import into the data processing system. Additionally, the system may be employed for generating video images, including digital video images in the .AVI, .WMV, .MOV, .RAM and .MPG formats.

The processor 228 may include microcontrollers and microprocessors programmed to receive data from the output amplifier 226 and exposure values from the exposure circuitry 220. In particular, processor 114 may include a central processing unit (CPU), a memory, and an interconnect bus. The CPU may include a single microprocessor or a plurality of microprocessors for configuring the processor 228 as a multi-processor system. The memory may include a main memory and a read-only memory. The processor 114 and/or the databases 230 also include mass storage devices having, for example, various disk drives, tape drives, FLASH drives, etc. The main memory also includes dynamic random access memory (DRAM) and high-speed cache memory. In operation, the main memory stores at least portions of instructions and data for execution by a CPU.

The mass storage 230 may include one or more magnetic disk or tape drives or optical disk drives, for storing data and instructions for use by the processor 228. At least one component of the mass storage system 230, possibly in the form of a disk drive or tape drive, stores the database used for processing the signals measured from the sensors 202a and 202b. The mass storage system 230 may also include one or more drives for various portable media, such as a floppy disk, a compact disc read-only memory (CD-ROM), DVD, or an integrated circuit non-volatile memory adapter (i.e. PC-MCIA adapter) to input and output data and code to and from the processor 228.

The processor 228 may also include one or more input/output interfaces for data communications. The data interface may be a modem, a network card, serial port, bus adapter, or any other suitable data communications mechanism for communicating with one or more local or remote systems. The data interface may provide a relatively high-speed link to a network, such as the Internet. The communication link to the network may be, for example, optical, wired, or wireless (e.g., via satellite or cellular network). Alternatively, the processor 228 may include a mainframe or other type of host computer system capable of communications via the network.

The processor 228 may also include suitable input/output ports or use the interconnect bus for interconnection with other components, a local display, keyboard or other local user interface 232 for programming and/or data retrieval purposes.

In certain embodiments, the processor 228 includes circuitry for an analog-to-digital converter and/or a digital-to-analog converter. In such embodiments, the analog-to-digital converter circuitry converts analog signals received at the sensors to digital signals for further processing by the processor 228.

The components of the processor 228 are those typically found in imaging systems used for portable use as well as fixed use. In certain embodiments, the processor 228 includes general purpose computer systems used as servers, workstations, personal computers, network terminals, and the like. In fact, these components are intended to represent a broad category of such computer components that are well known in the art. Certain aspects of the systems and methods described herein may relate to the software elements, such as the executable code and database for the server functions of the imaging system 200.

Generally, the methods described herein may be executed on a conventional data processing platform such as an IBM PC-compatible computer running the Windows operating systems, a SUN workstation running a UNIX operating system or another equivalent personal computer or workstation. Alternatively, the data processing system may comprise a dedicated processing system that includes an embedded programmable data processing unit.

Certain of the processes described herein may also be realized as one or more software components operating on a conventional data processing system such as a UNIX workstation. In such embodiments, the processes may be implemented as a computer program written in any of several languages well-known to those of ordinary skill in the art, such as (but not limited to) C, C++, FORTRAN, Java or BASIC. The processes may also be executed on commonly available clusters of processors, such as Western Scientific Linux clusters, which may allow parallel execution of all or some of the steps in the process.

Certain of the methods described herein may be performed in either hardware, software, or any combination thereof, as those terms are currently known in the art. In particular, these methods may be carried out by software, firmware, or microcode operating on a computer or computers of any type, including pre-existing or already-installed image processing facilities capable of supporting any or all of the processor's functions. Additionally, software embodying these methods may comprise computer instructions in any form (e.g., source code, object code, interpreted code, etc.) stored in any computer-readable medium (e.g., ROM, RAM, magnetic media, punched tape or card, compact disc (CD) in any form, DVD, etc.). Furthermore, such software may also be in the form of a computer data signal embodied in a carrier wave, such as that found within the well-known Web pages transferred among devices connected to the Internet. Accordingly, these methods and systems are not limited to any particular platform, unless specifically stated otherwise in the present disclosure.

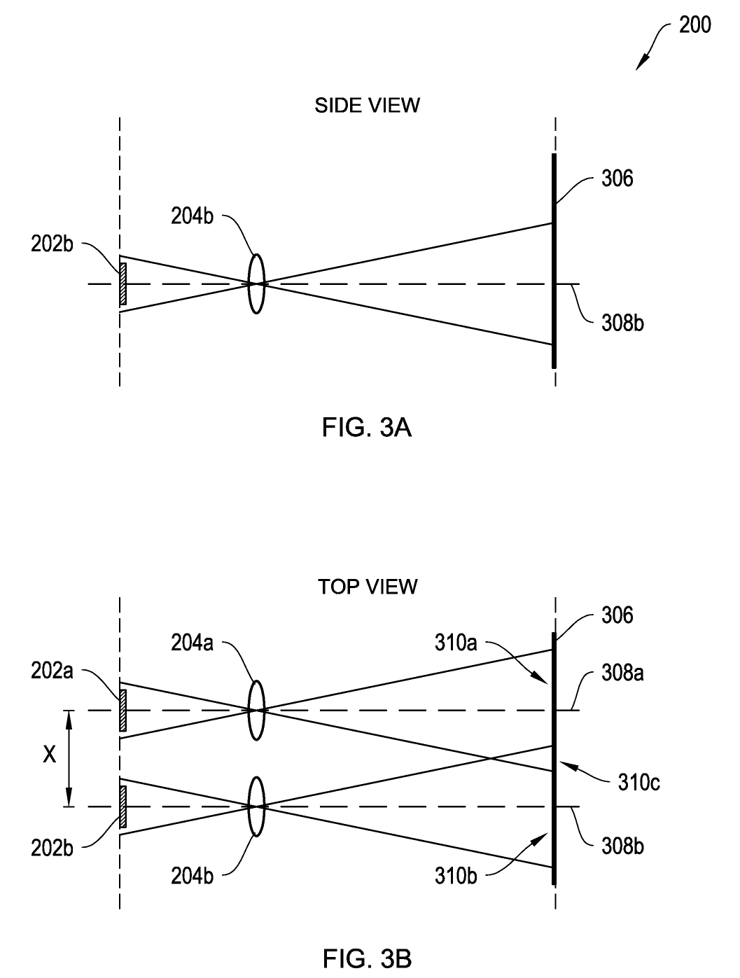

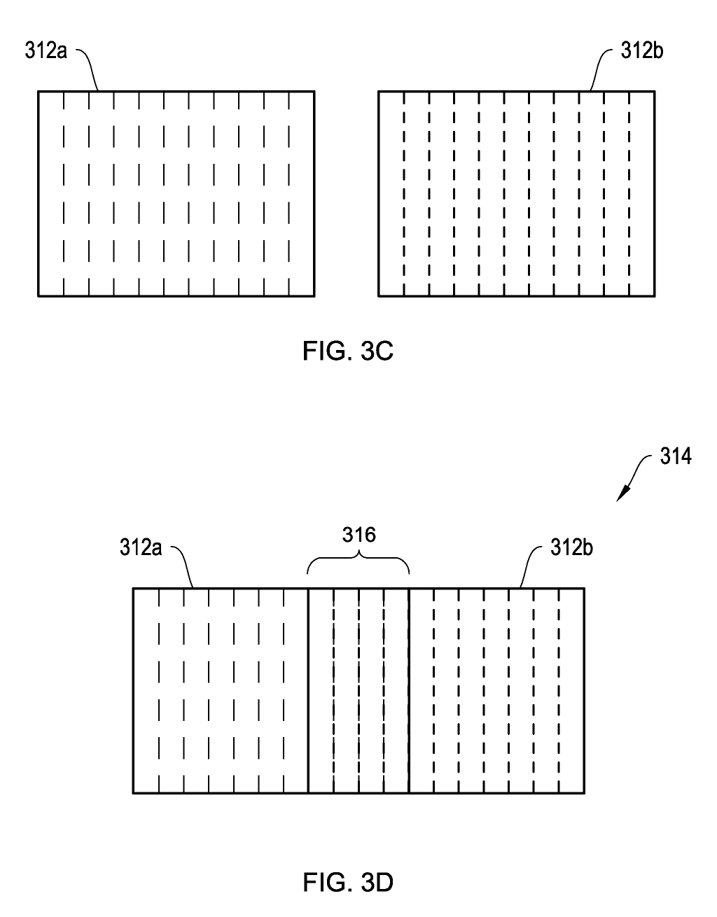

FIGS. 3A-D depict the illustrative multi-sensor imaging system 200, with adjacent imaging sensors 202a and 202b, lenses 204a and 204b, and target 306, which is a series of parallel, dashed lines oriented vertically. FIG. 3A and FIG. 3B show side and top views of imaging system 200, respectively. In this particular embodiment, the imaging sensors 202a and 202b are separated from each other by some distance X in a horizontal direction, as shown in FIG. 3B. Imaging sensor 202a and lens 204a have axes (imaging axis and optical axis, respectively) that are collinear and represented by axis 308a, and imaging sensor 202b and lens 204b have optical axes that are collinear and represented by axis 308b. Both axis 308a and axis 308b are perpendicular to the plane of target 306. Because imaging sensors 202a and 202b are offset from each other and have parallel optical axes, each sensor will capture an image of a slightly different portion of target 306. In other words each sensor-lens pair has a different, but overlapping, field of view. For example, sensor 202a may capture portion 310a of target 306, shown in image 312a of FIG. 3C, and sensor 202b may capture portion 310b of target 306, shown in image 312b of FIG. 3C. In certain embodiments, the captured portions may have an overlap portion 310c, imaged by both sensor 202a and sensor 202b. As in FIG. 1, because each sensor-lens pair has optical axes perpendicular to the surface of target 306 and collinear with the optical axes of the captured portions 310a and 310b of target 306, the resultant captured images will appear as parallel, dashed lines. After image capture, the two images 312a and 312a may be stitched together to form image 104 in FIG. 3D by aligning along overlap region 316, which corresponds to overlap portion 310c. Image stitching may be accomplished by hardware, such as processor 228, or software. Because the target lines in both images 312a and 312b are parallel, the images may be matched and stitched together with relatively little image processing and/or data interpolation required.

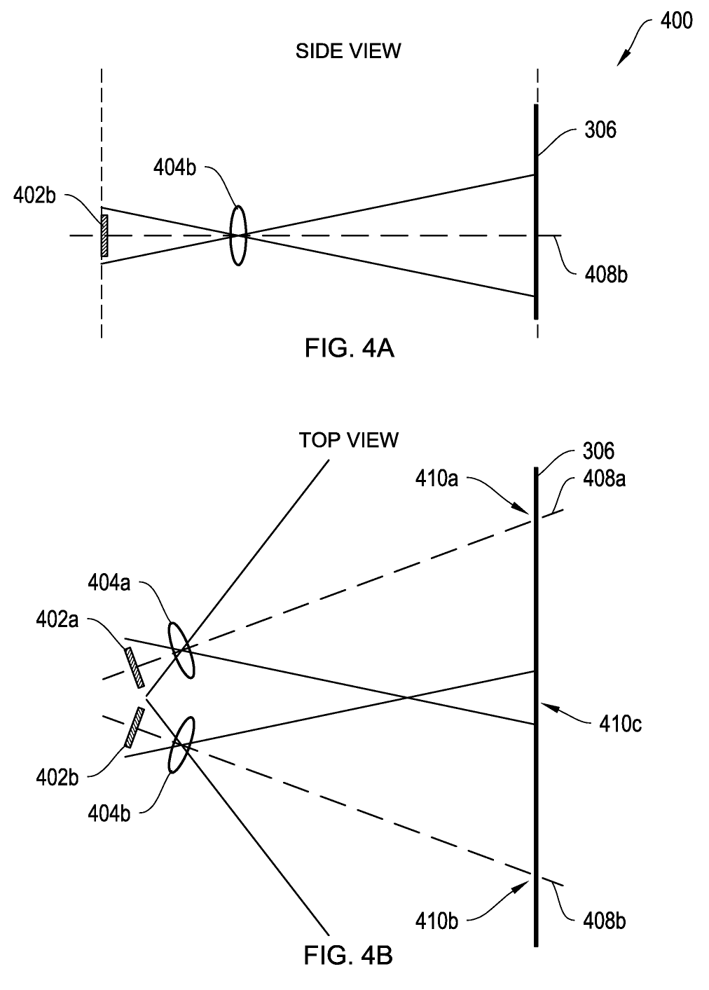

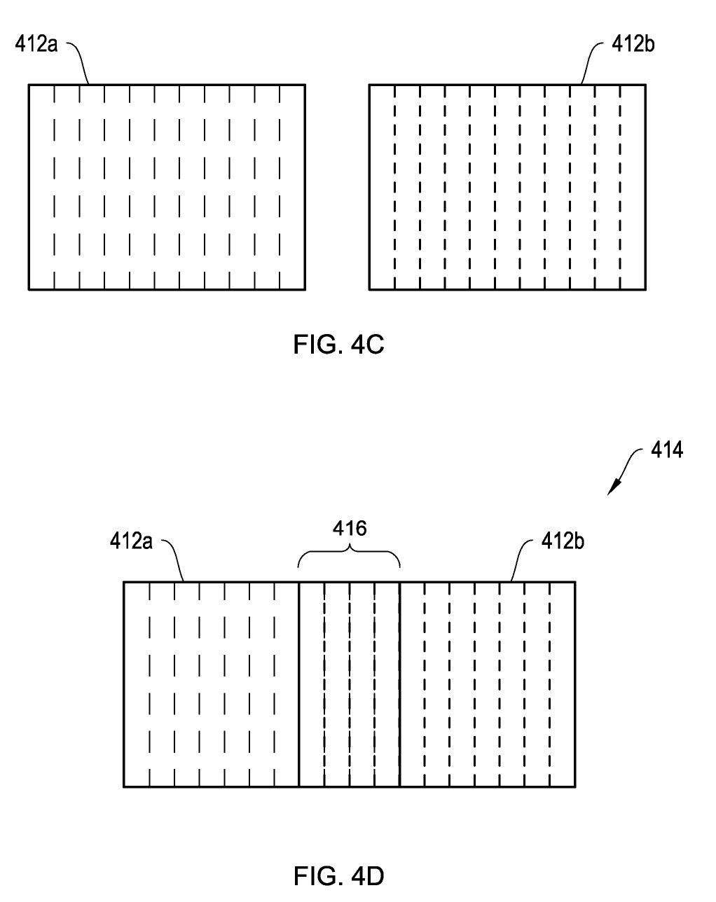

FIGS. 4A-D depict a multi-sensor imaging system 400, similar to the imaging system 200 described in FIGS. 3A-D. Multi-sensor imaging system 400 includes adjacent imaging sensors 402a and 402b, lenses 404a and 404b, and target 306, which in this example is a series of parallel, dashed lines oriented vertically. However, system 400 differs from system 200 in the orientation of the imaging sensors and lenses. Instead of the sensors being parallel to each other, in system 400 the sensors 402a and 402b are tilted horizontally with respect to each other. Although the now-tilted sensor optical axes 408a and 408b are no longer parallel to the plane of target 306, and hence are no longer collinear with the optical axes of the captured portions, the captured images 412a and 412b (corresponding to portions 410a and 410b of target 306) will still show parallel vertical lines, because the sensors are not tilted vertically. Hence, the images may still be matched and stitched together with relatively little image processing and/or data interpolation. However, matching these images may be more difficult if the sensors-lens pairs were tilted vertically instead of horizontally.

FIG. 5 depicts a side view of multi-sensor imaging system 200 imaging a target whose surface is tilted along an axis parallel to the sensor offset direction. In this situation, the target dashed lines will not appear as parallel lines in the images 508a and 508b, because the optical axes of the sensor-lens pairs are not perpendicular to the plane of the target. Instead, the parallel dashed lines will appear to converge toward the bottom of the image, as shown in images 508a and 508b. Stitching the images 508a and 508b together in this situation may require extensive image processing, because the overlap areas in the images do not match, as they did in the situation depicted in FIG. 3D.

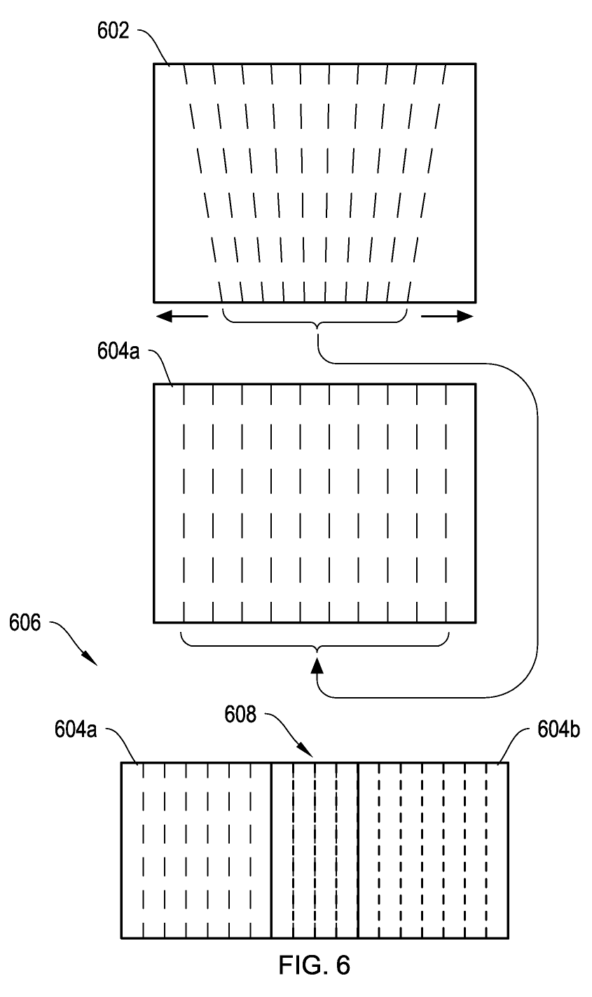

More particularly, FIG. 6 depicts a method for generating a single image from two overlapping images of a tilted scene via image processing. First, an image 602 similar to image 508a in FIG. 5 may be captured. Image 602 may then be processed so that the converging lines become parallel lines, resulting in modified image 604a. This processing step may involve data interpolation based on the original image data. Modified image 604a may then be stitched together along an overlap region 608 with another modified image 604b to form the final image 606. However, the final image 606 will likely have lower resolution and fidelity than a similar stitched image 314 (FIG. 3E), because of the image processing necessary to transform the converging lines into parallel lines. Image processing such as data interpolation generally results in loss of image data, resolution, and fidelity in the overlap region of the image and possibly elsewhere in the image, which may be undesirable.

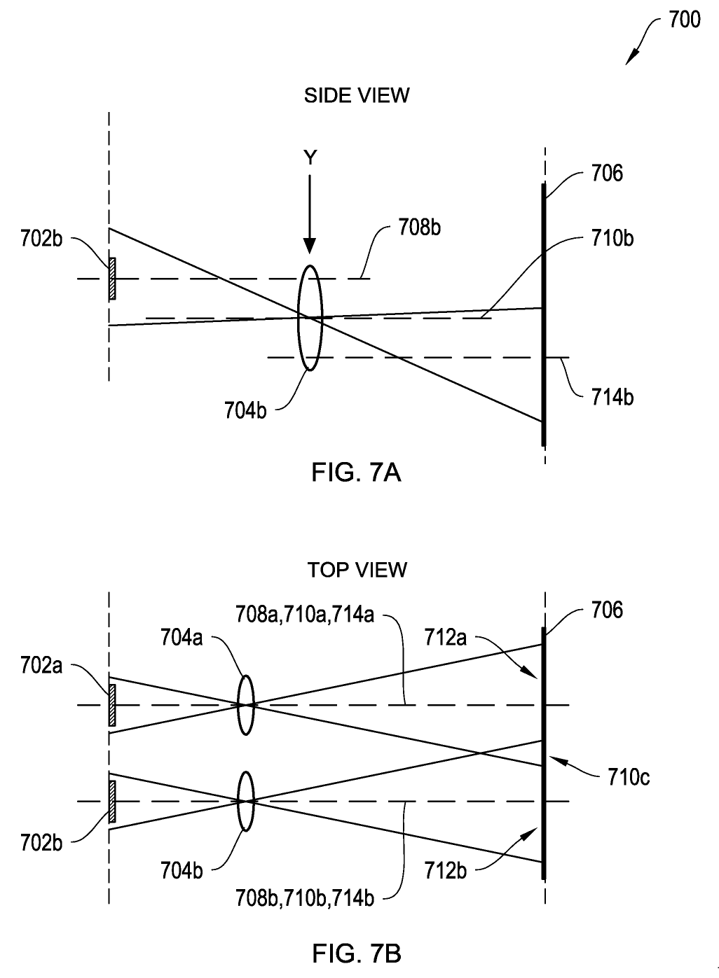

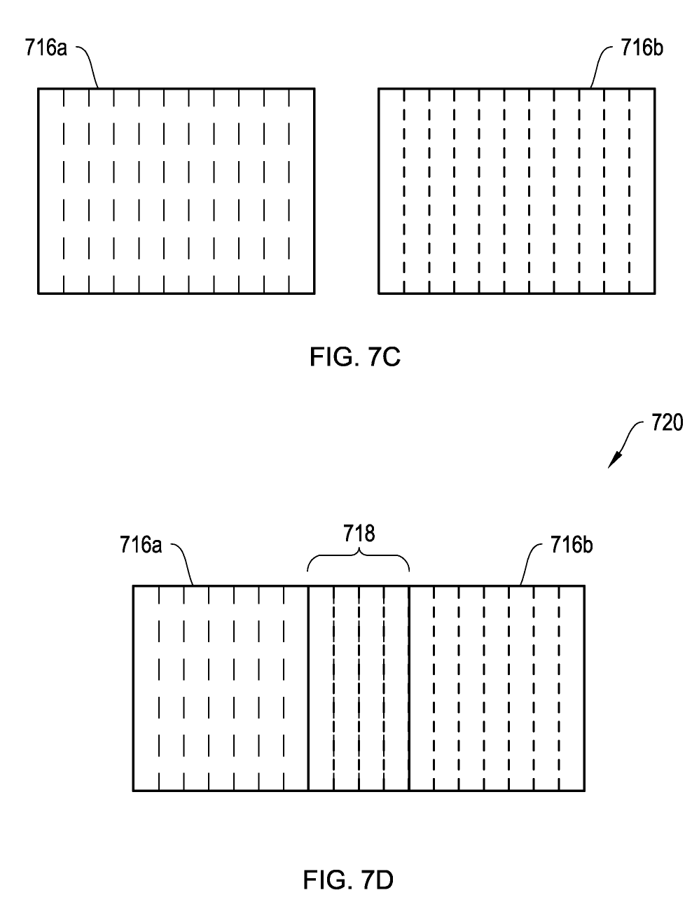

FIGS. 7A-D depict a method for generating a single image from two overlapping images of a scene at an angle according to an embodiment. In multi-sensor imaging system 700, shown in a side view (FIG. 7A) and a top view (FIG. 7B), the lenses have been offset from their original positions along a direction Y. After this offset, while the optical axes 708a and 708b of the sensors 702a and 702b are still parallel to the optical axes 710a and 710b of lenses 704a and 704b and the optical axes 714a and 714b of imaged areas 712a and 712b and perpendicular to the plane of target 706, the axes are no longer collinear. In this configuration, the field of view of the imaging sensors through the lenses changes depending on the offset of the lenses, but the parallel lines of target 706 will not longer appear to be converging in a captured image. Instead, the parallel target lines will remain parallel in captured images, as shown in overlapping images 716a and 716b in FIG. 7C. Therefore, stitching the overlapping images 716A and 716B together along overlap region 718 to form final image 720 as shown in FIG. 7D may no longer require extensive image processing and data interpolation, resulting in less data loss and higher image resolution and fidelity.

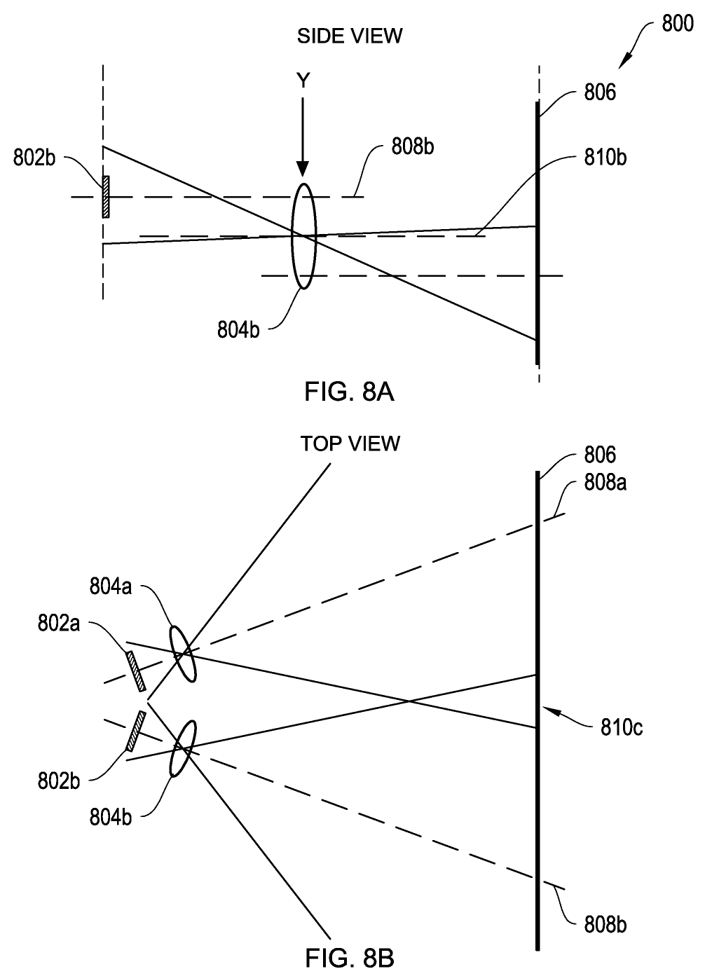

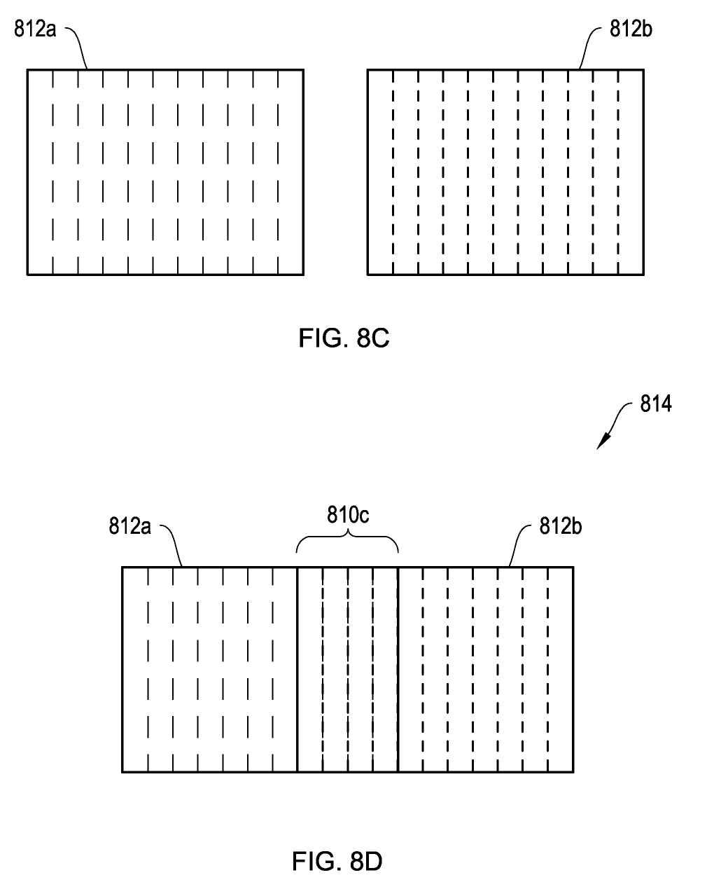

FIGS. 8A-D depict a method for generating a single image from two overlapping images of a scene at an angle according to another embodiment. Multi-sensor imaging system 800, shown in a side view (FIG. 8A) and a top view (FIG. 8B), is similar to the imaging system 700 shown in FIGS. 7A-D, but differs in the orientation of the imaging sensors and lenses. In multi-sensor imaging system 800, shown in a side view (FIG. 8A) and a top view (FIG. 8B), the lenses have been offset from their original positions along a direction Y. After this offset, the optical axes 808a and 808b of the sensors 802a and 802b are not parallel to the optical axes 810a and 810b of lenses 804a and 804b. In other words, instead of the sensors being parallel to each other, in system 800 the sensors are tilted horizontally with respect to each other. Although the now-tilted sensor optical axes 808a and 808b are no longer parallel to the plane of target 806, the captured images 812a and 812b will still show parallel vertical lines, because the sensors are not tilted vertically. Hence, the images may still be matched along overlap region 810c and stitched together with relatively little image processing and/or data interpolation, resulting in less data loss and higher image resolution and fidelity.

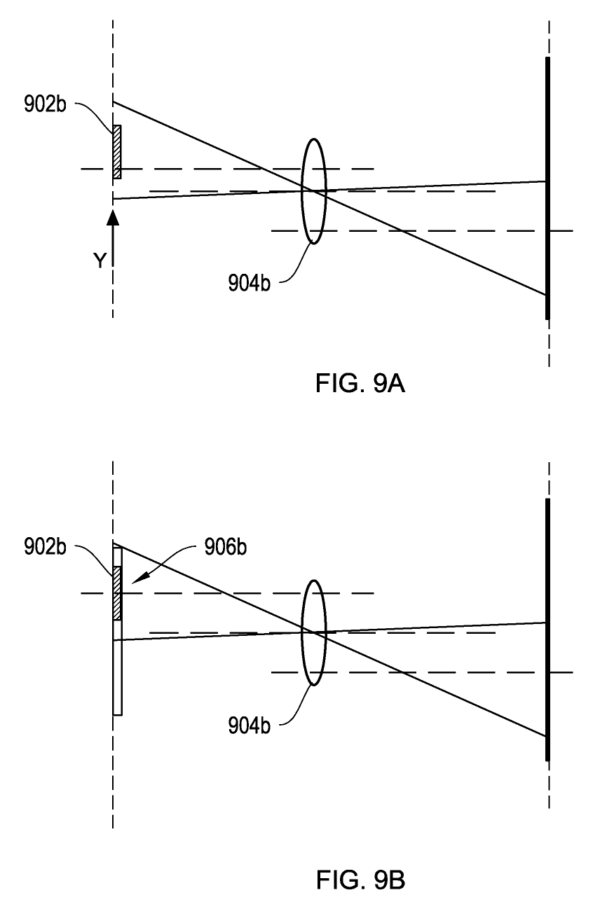

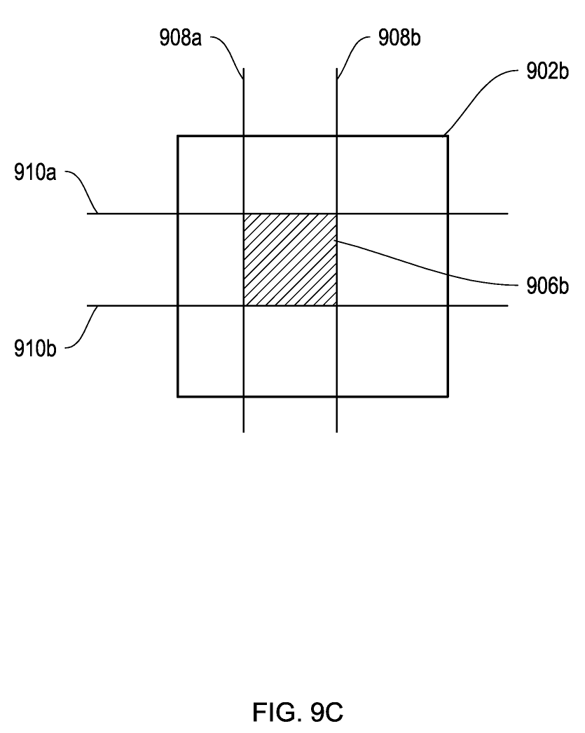

FIGS. 9A-C depict alternate methods for imaging a scene, according to illustrative embodiments. In one method, depicted in FIG. 9A, instead of offsetting the lens 904b, the imaging sensor 902b may be offset, as shown by the arrow Y. This may provide the same effect as the lens offset depicted in FIGS. 7A-D. In another method, depicted in a side view (FIG. 9B) and a front view (FIG. 9C), instead of physically offsetting either the lens 904b or the imaging sensor 902b, an active imaging area 906b of imaging sensor 902b may be offset. In this embodiment, the offset of the active imaging area 906b may be accomplished by changing the portion of the photosensitive element array that is read out. For example, in FIG. 9C, the photosensitive elements between columns 908a and 908b and rows 910a and 910b may be read out. The size and position of the active imaging area 906b may be varied simply by varying the addresses of the photosensitive elements to be read out. Moreover, the shape of the active imaging area 906b may also be controlled by varying the read-out photosensitive elements. For example, the active imaging area may be a rectangle, a square, a triangle, or any other shape. In some embodiments, two or more of the above methods may be combined. For example, an imaging system may have sensors, lenses, and active imaging areas that may be offset, independent of each other.

In certain embodiments, instead of panning or tilting the entire imaging system in order to change the field of view, only the lenses, sensors, or active imaging areas may be moved. The lenses and/or sensors may be shifted, tilted, or moved toward and/or away from each other. The lenses and/or sensors may be able to shift or be offset along any combination of the X, Y, and Z axes of a Cartesian coordinate system. For example, the lenses and/or sensors may be shifted from side to side (along an X-axis) or top-to-bottom/bottom-to-top (along Z-axis). In some embodiments, each lens, sensor, and/or active area may move independently of the other lenses, sensors, and/or active areas. In certain embodiments, the imaging system may include more than two sensors. These sensors may be mounted on a flat surface, a hemisphere or any other planar or nonplanar surface.

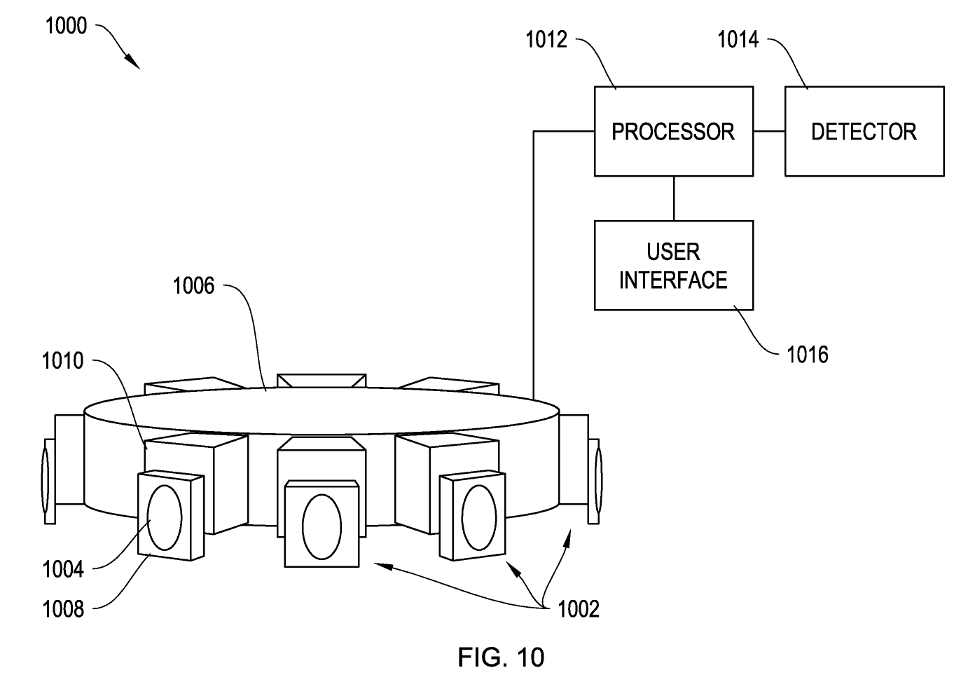

FIG. 10 depicts a multi-sensor imaging system 1000, according to an illustrative embodiment. In particular, imaging system 1000 includes a plurality of cameras 1002 arranged about the perimeter of a circular mount 1006. Each camera 1002 is facing a direction corresponding to a different, but overlapping, field of view. In certain embodiments, the multi-sensor imaging system 1000 may include a second row of cameras 1002 arranged in a circular mount below circular mount 1006. The second row of cameras 1002 may be arranged vertically below the gaps between the cameras 1002 in circular mount 1006. Alternatively, the second row of cameras 1002 may be arranged vertically adjacent to cameras 1002 in circular mount 1006. The multi-sensor imaging system 1000 may include a plurality of rows of cameras of 1002 to form a two-dimensional array of cameras. The plurality of cameras may be arranged in any suitable without departing from scope of the systems and methods described herein.

The imaging system 100 includes a processor 1012, a detector 1014 such as a motion detector, and a user interface 1016 which may include computer peripherals and other interface devices. The processor 1012 includes circuitry for receiving images from the cameras 1002 and combining these images to form a panoramic image of the scene. The processor 1012 may include circuitry to perform other functions including, but not limited to, operating the cameras 1002, and operating motion and offset mechanism. The processor 1012 is connected to a detector 1014, a user interface 1016 and other optional components (not shown). The detector 1014 includes circuitry for scanning a scene and/or detecting motion. In certain embodiments, upon detection, the detector 1014 may communicate related information to the processor 1012. The processor 1012, based on the information from the detector 1014, may operate one or more cameras 1002 to image a particular portion of the scene. The imaging system 1000 may further include other devices and components as depicted with reference to FIG. 2.

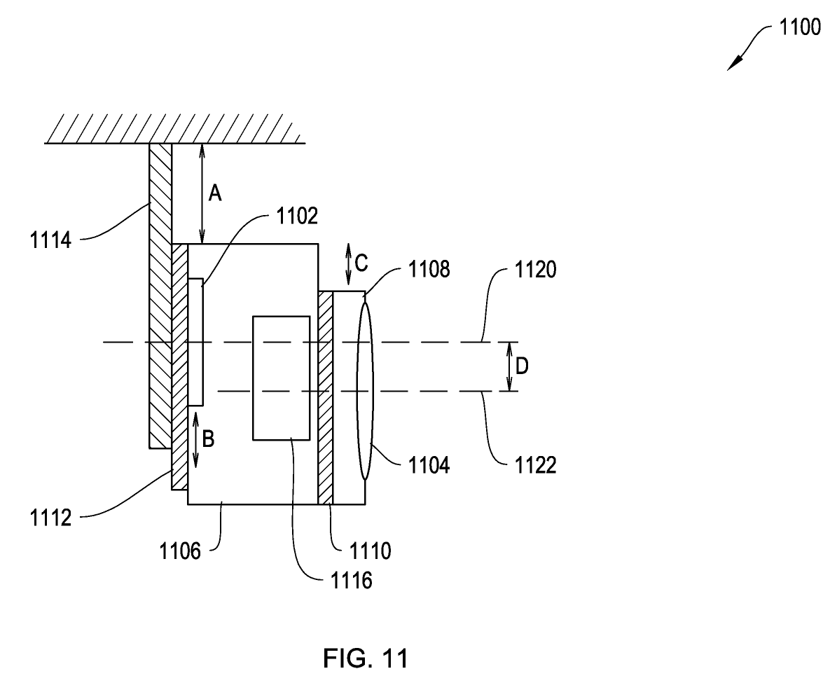

The camera 1002 includes a lens 1004 and a sensor. The lens 1004 is housed in lens housing 1008 and the sensor is housed in sensor housing 1010. The sensor housing 1010 may optionally include processing circuitry for performing one or more functions of the processor 1012. As will be described in more detail with reference to FIG. 11, the sensor housing 1010 may further include an offsetting mechanism for shifting the optical axis of the lens relative to the imaging axis of the active area of the sensor. In particular, FIG. 11 depicts an exemplary camera 1100, to be used in a multi-sensor imaging system such as systems 200, 400, 700, 800, 900 and 1000. Camera 1100 includes a sensor 1102 positioned behind a lens 1104. The lens 1104 is positioned within housing 1108 and the sensor 1102 is positioned within housing 1106.

The lens 1104 may be a single lens or a lens system comprising a plurality of optical devices such as lens, prisms, beam splitters, mirrors, and the like. The sensor 1102 may include one or more active areas that may partially or completely span the area of the sensor. The lens 1104 may include an optical axis or a principle optical axis 1122 that pass through the center of the lens 1104. The sensor 1102 may include an imaging axis 1120 that passes through the sensor 1102 and intersects the center or substantially near the center of an active area of the sensor 1102. The optical axis 1122 and the imaging axis 1120 are separated by an offset D.

The offset D may be generated by at least one of shifting the lens 1104, the sensor 1102 or modifying the active area on the sensor 1102. The lens housing 1108 includes an offset mechanism 1110 for moving the lens 1104 along direction C. The direction C is along the direction parallel to the plane of the lens 1104 and the sensor 1102. The sensor housing 1106 also includes an offset mechanism 1112 for moving the sensor 1102 along direction B. The direction B is along the direction parallel to the plane of the lens 1104 and the sensor 1102. In certain embodiments, camera 1100 includes an optical offset mechanism 1116 such as a prism. Prisms and other optical devices may be used to shift and offset the optical axis 1122 of lens 1104.

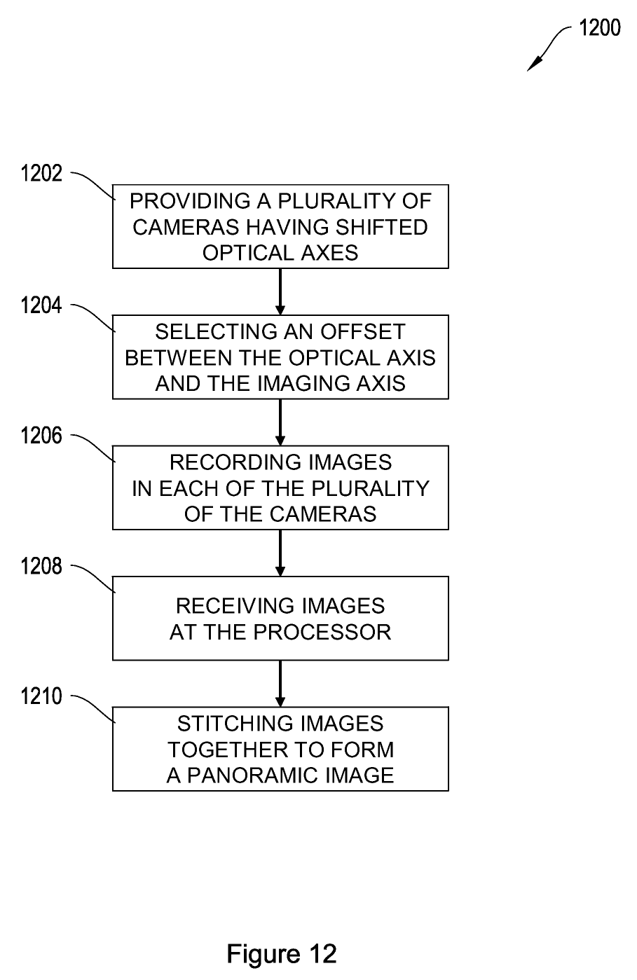

The camera 1100 is mounted on a moving platform 1114. The moving platform 1114 moves the camera along direction A. As will be described below with reference FIG. 12, the offset D may be selected based on, among other things, the location of the camera in relation to the scene being imaged and movement along direction A. For example, a surveillance camera mounted high on a wall to monitor movement on the ground, may be moved up and down the wall. As the camera is moved down the wall and towards the ground, the offset between the optical axis and the imaging axis may be reduced. On the other hand, as the camera is moved up the wall and away from the ground, the offset between the optical axis and the imaging axis may be increased. The offset D may be selected and dynamically adjusted and adapted so that the field of view of a moving camera remains substantially constant.

FIG. 12 is a flow chart depicting a process 1200 for imaging a scene, according to an illustrative embodiment. The process 1200 includes providing a multi-sensor imaging system having a plurality of cameras having offset optical and imaging axes (step 1202). Such an imaging system and corresponding cameras may be similar to imaging systems and cameras in FIGS. 1-11. The process further includes selecting an offset between the optical and imaging axis. In certain embodiments, the camera may have a fixed offset. The offset may be selected based on, among other things, the location of the camera in relation to the scene being imaged and the desired field of view. In other embodiments, the offset may be selected based on the movement of the camera. A processor may control the movement of various components of the imaging system to dynamically, and optionally in real-time, adjust and modify the offset. The process 1200 further includes recording images on each of the plurality of cameras (step 1206). A processor may be configured to receive these recorded images. The process 1200 includes stitching these images together to form a panoramic image (step 1210).

Variations, modifications, and other implementations of what is described may be employed without departing from the spirit and scope of the invention. More specifically, any of the method and system features described above or incorporated by reference may be combined with any other suitable method or system features disclosed herein or incorporated by reference, and is within the scope of the contemplated inventions. The systems and methods may be embodied in other specific forms without departing from the spirit or essential characteristics thereof. The foregoing embodiments are therefore to be considered in all respected illustrative, rather than limiting of the invention. The teachings of all references cited herein are hereby incorporated by reference in their entirety.

1. A multi-sensor system for imaging a scene, comprising:
a plurality of cameras, each camera including
a lens having an optical axis, and
a sensor, positioned behind the lens, having an active area for imaging a portion of the scene and an imaging axis, perpendicular to the active area, that intersects at a center region of the active area,
wherein the optical axis is offset from the imaging axis, and
wherein at least two cameras are adjacent to one another and have overlapping fields of view; and
a processor having circuitry for receiving the images from the sensors, and generating a panoramic image by combining the image from each of the plurality of cameras.

2. The multi-sensor system of claim 1, wherein the plurality of cameras are positioned above the scene and the optical axis is vertically offset from the imaging axis such that optical axis is below the imaging axis.

3. The multi-sensor system of claim 1, wherein the plurality of cameras are positioned below the scene and the optical axis is vertically offset from the imaging axis such that optical axis is above the imaging axis.

4. The multi-sensor system of claim 1, further comprising one or more offset mechanisms connected to one or more lenses for shifting the optical axis relative to the imaging axis.

5. The multi-sensor system of claim 4, wherein the offset mechanism includes at least one prism.

6. The multi-sensor system of claim 4, wherein the offset mechanism is coupled to the processor and the processor includes circuitry for controlling the offset mechanism and shifting the one or more lenses.

7. The multi-sensor system of claim 4, further comprising a detection mechanism configured to detect movement in the scene, wherein the processor includes circuitry for controlling the offset mechanism based on movement detected by the detection mechanism.

8. The multi-sensor system of claim 1, further comprising one or more offset mechanisms connected to one or more sensors for shifting the imaging axis relative to the optical axis.

9. The multi-sensor system of claim 8, wherein the offset mechanism is coupled to the processor and the processor includes circuitry for controlling the offset mechanism and shifting the one or more sensors.

10. The multi-sensor system of claim 9, wherein the processor includes circuitry for changing the active area on one or more sensors, thereby shifting one or more imaging axes.

11. The multi-sensor system of claim 10, wherein the processor includes circuitry for changing the addresses of one or more photosensitive elements to be read out.

12. The multi-sensor system of claim 1, wherein the active area is smaller than a surface area of the sensor.

13. The multi-sensor system of claim 1, wherein the active area spans the sensor.

14. The multi-sensor system of claim 1, wherein the plurality of cameras are arranged on a perimeter of a circular region for spanning a 360-degree horizontal field of view.

15. The multi-sensor system of claim 1, wherein the plurality of cameras are mounted on a hemispherical surface.

16. The multi-sensor system of claim 1, wherein the plurality of cameras includes two cameras arranged horizontally adjacent to one another with partially overlapping fields of view.

17. The multi-sensor system of claim 1, wherein the plurality of cameras are mounted on a moving platform and the offset between the optical axis and the imaging axis is determined based on the motion of the moving platform.

18. A method of imaging a scene, comprising
providing a first camera having a first field of view and a second camera having a second field of view that at least partially overlaps with the first field of view, wherein the first and second cameras each include a lens and a sensor, the lens having an optical axis offset from an axis perpendicular to the sensor and intersecting near a center of an active area of the sensor;
recording a first image of a portion of a scene on the active area at the first camera, and recording a second image of a portion of the scene on the active area at the second camera;
receiving at a processor the first image and the second image; and
generating a panoramic image of the scene by combining the first image with the second image.

19. The method of claim 18, further comprising a plurality of cameras positioned adjacent to at least one of the first and second camera.

20. The method of claim 18, further comprising determining a position for the first and second camera in relation to the location of the scene.

21. The method of claim 20, further comprising, selecting the offset between the optical axis and the imaging axis in each of the first and second camera based at least on the location of the scene relative to the position of the first and second camera.

22. The method of claim 18, wherein the offset between the optical axis and imaging axis in at least one of the first and the second camera is generated by physically offsetting at least one of the lens and sensor.

23. The method of claim 18, wherein the active area is smaller than the sensor in at least one of the first and second camera, and the offset between the optical axis and imaging axis in the first and the second camera is generated by changing the active area on the sensor in at least one of the first and second camera.

24. The method of claim 23, wherein changing the active area includes changing a portion of photosensitive elements being read out.
